(19) United States
(12) Patent Application Publication
(10) Pub. No.: US 2007/0159677 A1
(43) Pub. Date: Jul. 12, 2007

(54) Light closure and method for controlling the same

(76) Inventors: Gerhard Doering, Schloeben (DE); Tobias Kaufhold, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/586,888

(22) PCT Filed: Feb. 17, 2005
(86) PCT No.: PCT/EP05/01597

§ 371 Date: Jul. 20, 2006

(30) Foreign Application Priority Data
Feb. 20, 2004 (DE) 10 2004 008 326.6

(51) Int. Cl. G02B 26/02

(52) U.S. Cl. 359/230

(57) ABSTRACT

The present invention is directed to a motor-operated optical shutter for opening and closing the illumination beam path in optical devices. The optical shutter, according to the invention, for the illumination beam path in optical devices comprises a mounting unit which is provided with a diaphragm aperture, a stepper motor which is mounted at the mounting unit, and a shutter element which is connected to the motor shaft of the stepper motor for opening and closing the diaphragm aperture. A two-phase stepper motor with a large full step angle is preferably used. The two-phase stepper motor is connected to a control unit and carries out the required movement of the shutter element at a short distance from the motor shaft. The solution according to the invention provides a very economical and simple optical shutter for optical devices. The commercially available stepper motors that are used have a greater numbers of poles and a fully enclosed magnet air gap field and enable short closing and opening times of the optical shutter. With these stepper motors, the usual disadvantage of a relatively costly control can be eliminated by a simple control method.

### CROSS-REFERENCE TO RELATED APPLICATIONS

This application claims priority of International Application No. PCT/EP2005/001597, filed Feb. 17, 2005 and German Application No. 10 2004 008 326.6, filed Feb. 20, 2004, the complete disclosures of which are hereby incorporated by reference.

### FIELD OF THE INVENTION

The present invention is directed to a motor-operated optical shutter for opening and closing the illumination beam path in optical devices.

### DESCRIPTION OF THE RELATED ART

In optics and especially in microscopy according to the prior art, there is a large number of variants for opening and closing optical beam paths in which a shutter element is slid, pivoted, swung, or the like, into the beam path. The shutter elements are moved by different drive mechanisms. Pull-type magnets and rotary magnets or motors with end positions are used most commonly.

In displacement systems, as they are called, the shutter element is slid directly into the beam path. The driving is usually carried out by means of pull-type magnets.

In pivoting systems, the shutter element is rotated into the beam path. The center of rotation is, at the same time, the point of application of the rotary drive mechanism. As a rule, rotary magnets or motors are used in this case.

Another variant is swinging systems. In these solutions, the shutter is swung into the beam path. The shutter element rotates around a fixed point. The drive is usually carried out in this case by pull-type magnets. The longitudinal movement of the pull-type magnet is transformed into a rotational movement.

DE 100 29 444 A1 describes a solution, preferably for laser scanning microscopes, in which the shutter parts are driven by magnets. The arrangement has, in addition, devices for monitoring the operation of the interruption device for ensuring safety when using lasers.

Patent EP 0 482 340 A1 describes a solution in which a shutter part in the form of a disk with openings is moved directly by motor and accordingly opens and closes the beam path. The shutter part is moved similar to a filter wheel by means of a stepper motor.

U.S. Pat. No. 6,046,836 A1, U.S. Pat. No. 6,215,575 B1, and U.S. Pat. No. 6,466,353 B2 describe a light modulator which is provided for pivoting operation and in which the shutter is actuated by a stepper motor. While a static operation can be realized by this arrangement, the coil current cannot be reduced for a corresponding control without considerable expenditure, and the power loss and, therefore, the heating of the motor, is relatively high. Further, the arrangement has the disadvantage that the angle of rotation corresponds to only one full step of a stepper motor. In order to cover an aperture having a diameter of about 1 cm, either a very large full step is required, which results in a small torque of the stepper motor, or the stepper motor must be placed at a correspondingly large distance from the aperture to be closed in order to realize the required stepping path. This would greatly increase the space required for the total assembly.

U.S. Pat. No. 5,739,942 describes a microceramic optical shutter comprising a shutter flap with a permanent magnet and a single-phase stator. Depending on the current direction, the shutter flap can be opened and closed. This solution has the disadvantage that it requires a relatively high one-time expenditure for producing the sinter molds for the ceramic and molded parts for the permanent magnet. The torque is relatively low because of the low number of only two poles. Another disadvantage is the poor use of the magnetic air gap field due to the relatively small surface of the stator pole surrounding the permanent magnet rotor. The limiting pins which are fixed in the ceramic mold limit the movement of the optical shutter. The movement range is appreciably smaller than a full step when a magnetically stable position is considered as a full step.

Magnet drives have the disadvantage that they usually have large dimensions so that the required forces can be realized. Further, return springs are often required in addition. In order to maintain a corresponding position, current must generally be applied to the arrangement continuously resulting in high power loss (heat). Further, small full step angles can hardly be implemented with magnet drives.

### OBJECT AND SUMMARY OF THE INVENTION

It is the primary object of the present invention to develop an optical shutter for optical devices in which a commercially available stepper motor is used to drive the optical shutter, and the stepper motor is to be operated without an expensive control.

According to the invention, this object is met by an optical shutter for the beam path in optical devices comprising a mounting unit which is provided with a diaphragm aperture, a stepper motor which is mounted at the mounting unit and a shutter element which is connected to the motor shaft of the stepper motor for opening and closing the diaphgram aperture. The stepper motor is a two-phase stepper motor with a large full step angle. The two-phase stepper motor is connected to a control unit and carries out the required movement of the shutter element at a short distance from the motor shaft.

The optical shutter for the beam path of optical devices comprises a mounting unit provided with a diaphragm aperture, a stepper motor which is mounted at the mounting unit, and a shutter element connected to the motor shaft of the stepper motor for opening and closing the diaphragm aperture. A two-phase stepper motor with a large full step angle carrying out the required movement of the shutter element at a short distance from the motor shaft is preferably used. The movement of the shutter element fastened to the motor shaft is carried out in that the 180-degree rotation of the electromagnetic field in the stator of the stepper motor, and therefore a corresponding rotation of the motor shaft by n full steps, is effected by a control unit.

The present invention provides an economic solution for opening and closing beam paths in optical devices. The driving of the swiveling element, which is constructed in the form of a circle segment, for example, is carried out by means of a commercially available stepper motor.

The invention will be described in the following with reference to an embodiment example.

### BRIEF DESCRIPTION OF THE DRAWINGS

In the drawings:

FIG. 1 shows the arrangement of an optical shutter in the beam path of a microscope;

FIG. 2 shows the static torque curve of a 15 M 20 S 13 type stepper motor;

FIG. 3a shows the torque vector diagram of a control cycle; and

FIG. 3b shows the torque vector diagram of a control cycle with mechanical limiting by stop pins.

### DESCRIPTION OF THE PREFERRED EMBODIMENTS

FIG. 1 shows the arrangement of the optical shutter, according to the invention, in the beam path of a microscope. The proposed optical shutter for the illumination beam path 1 in optical devices comprises a mounting unit 2 which is provided with a diaphragm aperture, a stepper motor 3 which is mounted at the mounting unit 2, and a shutter element 4 which is connected to the motor shaft of the stepper motor for opening and closing the diaphragm aperture. A two-phase stepper motor 3 with a large full step angle is preferably used. This two-phase stepper motor 3 is connected to a control unit (not shown) and carries out the required movement of the shutter element 4 at a short distance from the motor shaft. The use of a two-phase stepper motor 3 with claw-pole construction of the rotor and stator is particularly advantageous. The movement of the shutter element 4 can be limited by a stop pin 5 to a movement range smaller than n full steps in each of the two end positions.

When the diaphragm aperture provided in the mounting unit 2 is not covered by the shutter element 4, the illumination light reaches the object plane 8 via the illumination beam path 1. An object arranged in the object plane 8 can then be viewed via the illumination beam path 7 of the microscope.

It is also advantageous to provide an end-position sensor 6 which is fastened to the mounting unit 2 and which determines the position of the shutter element 4.

In the method for controlling the optical shutter, the movement of the shutter element 4 fastened to the motor shaft is carried out in that the 180-degree rotation of the electromagnet field in the stator of the stepper motor 3, and therefore a corresponding rotation of the motor shaft of n full steps, preferably 2 full steps, is implemented by the control unit. For this purpose, a reversal of the current direction is carried out by the control unit in both windings of the two-phase stepper motor 3.

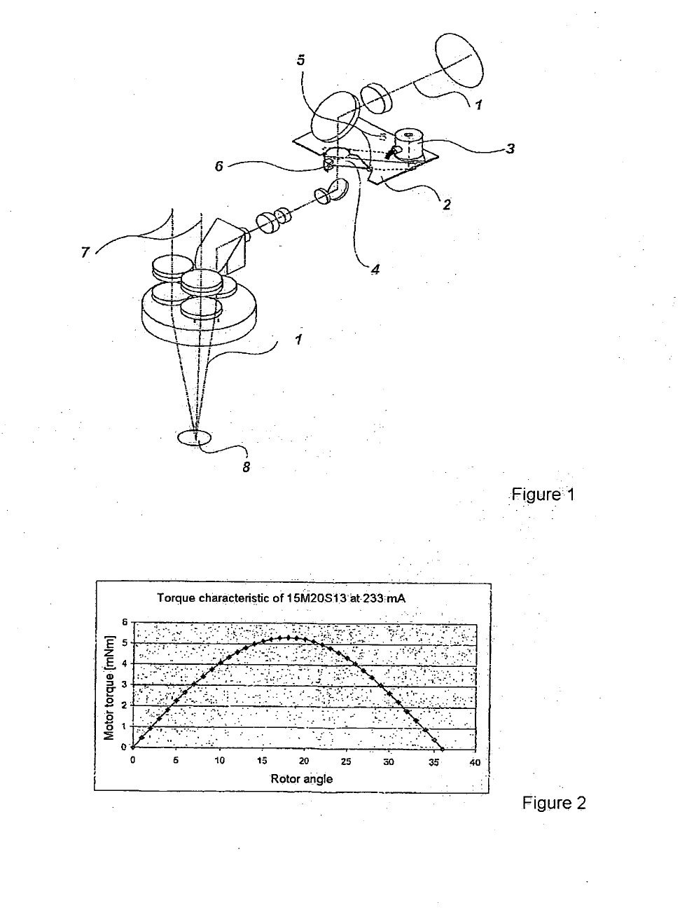

The supply of current to one winding, or both windings simultaneously, of a two-phase stepper motor depends on the static torque curve of the stepper motor. In the present construction, a stepper motor by the U.S. manufacturer DANAHER MOTION (www.danahermotion.com) which sells stepper motors under the trade name THOMSON is used. FIG. 2 shows the static torque curve of a 15 M 20 S 13 type stepper motor having the following specifications:

| | |
|---|---|
| Type | 15M020S1B |
| full step angle | 18 |
| holding torque | 3.88 mNm |
| winding resistance | 40 ohms |
| current rating | 125 mA |
| voltage rating | 5 V |

In simple stepper motors with claw-pole construction of the rotor and stator, it is usually better to supply current to both windings in order to obtain steeper torque curves.

According to FIG. 2, a stable operating point (zero crossover with positive edge) occurs at a rotor angle of 0°. With reversal of current direction in both windings, the torque characteristic turns down at the horizontal axis, and a stable operating point occurs with a rotor angle rotation of 36°. When an alternating current direction reversal is carried out in both windings, the rotor of the stepper motor moves back and forth by 36° in each instance, which corresponds to two full steps at an angle of 18°.

In order to prevent the rotor from rotating in the opposite direction, a directed rotational direction must be forced.

A retarded current direction reversal is realized in the individual windings of the stepper motor 3 by the control unit for specifically directed movement of the shutter element 4.

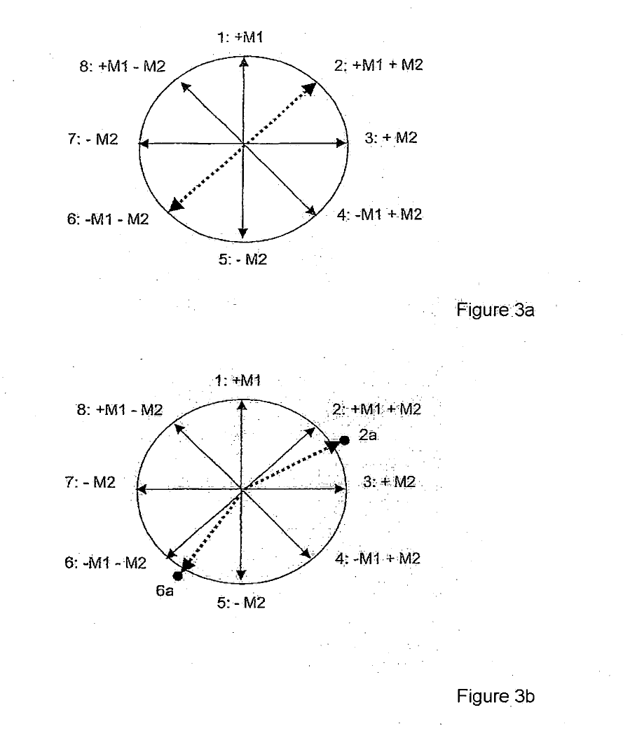

The torque vectors illustrated in FIG. 3a show the movement states of the magnetic field in the stator for a cycle in half-step operation. For the 15 M 20 S 13 type stepper motor, jumping occurs only between states 2 and 6 of the torque vector diagram. The current direction is changed simultaneously in the two windings for this purpose. The rotor of this stepper motor with a full step angle of 18° moves by exactly two full steps, which corresponds to a movement range of 36°.

With a simultaneous current direction reversal, it is random whether the rotor rotates out of position 2 to position 6 to the right (2-3-4-5-6) or to the left (2-1-8-7-6). It can be seen from FIG. 3a that a forced movement over states 2-3-4-5-6 can be carried out by a timed sequence of current direction reversal. The current direction reversal must take place with a time delay at winding 2. For a forced movement in the opposite direction over states 6-5-4-3-2, the current direction reversal must take place with a time delay at winding 1.

However, a specifically directed movement of the shutter element 4 can also be achieved when the mechanical rotation of the rotor is limited by stop pins to a movement range smaller than n, preferably 2, full steps and a simultaneous current direction reversal in the individual windings of the stepper motor 3 is carried out by the control unit.

The control of the shutter element 4 is considerably simplified through the use of mechanical stop pins 5 because a retarded current direction reversal in the individual windings of the stepper motor 3 can be dispensed with. FIG. 3b shows the torque vector diagram of a control cycle with mechanical limiting by stop pins 5 in positions 2a and 6a.

The optical shutter can be fastened directly to the motor shaft and its movement limited by mechanical stop pins 5. The movement range must be somewhat less than twice the full step angle so as to ensure a directed stepping movement. The optical shutter is fastened to the motor shaft in such a way that it contacts the mechanical stop pins when current is applied to the winding. The movement range which is limited by the pins is slightly smaller than twice the full step so that a torque is generated in the respective position of the optical shutter which presses the optical shutter against the mechanical stop pins. A very accurate positioning of the optical shutter is achieved in this way. Unlike a DC motor, the movement of the rotor of a stepper motor against a mechanical stop does not cause increased power dissipation in the motor.

The rated current of the stepper motor is no longer necessary for holding against the mechanical stops; the current can be reduced to a required minimum value for this time period. Because of the pole shape of the rotor and stator, some stepper motors have a self-holding torque though the permanent magnet rotor which can be sufficient for holding the positions at the mechanical stops. In such cases, it is even possible to switch off the winding currents of the individual windings of the stepper motor after reaching the end position of the shutter element.

For safety reasons, it must be ensured when putting the optical device into operation, e.g., by evaluating the signal of the end position sensor, that the diaphragm aperture is closed by the shutter element. But this can also be achieved by applying a predetermined current direction to the windings of the stepper motor when the optical device is put into operation.

The solution according to the invention provides a very economical and simple optical shutter for the beam path of optical devices. The commercially available stepper motors that are used have a greater numbers of poles and a fully enclosed magnet air gap field and enable short closing and opening times of the optical shutter. With these stepper motors, the usual disadvantage of a relatively costly control can be eliminated by means of a simple control method.

While the foregoing description and drawings represent the present invention, it will be obvious to those skilled in the art that various changes may be made therein without departing from the true spirit and scope of the present invention.

1-12. (canceled)

13. An optical shutter for the beam path in optical devices comprising:
a mounting unit which is provided with a diaphragm aperture;
a stepper motor which is mounted at the mounting unit; and
a shutter element which is connected to the motor shaft of the stepper motor for opening and closing the diaphragm aperture;
said stepper motor being a two-phase stepper motor with a large full step angle;
said two-phase stepper motor being connected to a control unit and carrying out the required movement of the shutter element at a short distance from the motor shaft.

14. The optical shutter according to claim 13, wherein a two-phase stepper motor with a claw-pole construction of the rotor and stator is used.

15. The optical shutter according to claim 13, wherein the movement of the shutter element is limited to a movement range of less than n full steps by a stop pin in the two end positions, respectively.

16. The optical shutter according to claim 13, wherein an end-position sensor which is fastened to the mounting unit and determines the position of the shutter element is provided in addition.

17. A method for controlling an optical shutter according to claim 13, comprising the steps of:
carrying out movement of the shutter element fastened to the motor shaft in that the 180° rotation of the electromagnetic field in the stator of the stepper motor, and, therefore, a corresponding rotation of the motor shaft by n full steps, is carried out by the control unit.

18. The method according to claim 17, wherein a reversal of the current direction in the two windings of the stepper motor is carried out by the control unit for moving the shutter element that is fastened to the motor shaft.

19. The method according to claim 17, wherein a retarded reversal of the current direction in the individual windings of the stepper motor is carried out by the control unit for directed movement of the shutter element.

20. The method according to claim 17, wherein a simultaneous reversal of the current direction in the individual windings of the stepper motor is carried out by the control unit for the directed movement of the shutter element when the mechanical rotation of the rotor is limited by stop pins to a movement range less than n full steps.

21. The method according to claim 17, wherein the winding currents of the individual windings of the stepper motor are reduced after reaching the end position of the shutter element, wherein the end position is reached after n full steps or when one of the stop pins is contacted.

22. The method according to claim 17, wherein the winding currents of the individual windings of the stepper motor are switched off, respectively, after the end position of the shutter element is reached when the self-holding torque of the stepper motor is large enough to hold the shutter element in the respective end position.

23. The method according to claim 17, wherein the closing of the diaphragm aperture by the shutter element is ensured when the optical device is put into operation by evaluating the signal of the end-position sensor.

24. The method according to claim 17, wherein the windings of the stepper motor are acted upon by a predetermined current direction when the optical device is put into operation in order to ensure that the diaphragm opening is closed by the shutter element
